(19) United States
(12) Patent Application Publication
(10) Pub. No.: US 2026/0283763 A1
(43) Pub. Date: Sep. 24, 2026

(54) METHODS AND DEVICES FOR MAKING CUSTOMIZED PADS FOR DENTAL APPLIANCES

(71) Applicant: Stuart Levy, Mason, OH (US)

(72) Inventor: Stuart Levy, Mason, OH (US)

(21) Appl. No.: 19/573,069

(22) Filed: Mar. 20, 2026

Related U.S. Application Data
(60) Provisional application No. 63/776,479, filed on Mar. 24, 2025.

(51) Int. Cl. A61C 13/07; A61C 13/00; A61C 13/34; B33Y 80/00

(52) U.S. Cl. CPC A61C 13/0025; A61C 13/0004; A61C 13/0018; A61C 13/34; B33Y 80/00

(57) ABSTRACT

A method of making and shipping or delivering an impression of a gum facing portion of a dental appliance includes pressing the gum facing portion of the dental appliance against a putty in an impression container. The method also includes allowing the putty to harden to make the impression and removing the dental appliance from the impression after the putty has hardened. The impression container with the impression of the gum facing portion of the dental appliance is then shipped or delivered.

### CROSS REFERENCE TO RELATED APPLICATIONS

This application claims the priority of U.S. Provisional Patent Application Ser. No. 63/776,479, filed on Mar. 24, 2025, the disclosure of which is incorporated herein by reference in its entirety.

This application is also generally related to the subject matter disclosed in U.S. application Ser. No. 18/921,272, filed on Oct. 21, 2024, the disclosure of which is incorporated herein by reference in its entirety.

### TECHNICAL FIELD

The present disclosure generally relates to methods and devices for making adhesive pads for dental appliances, making impressions of dental appliances, and specifically making impressions of dental prosthetics, such as dentures, for the purpose of making adhesive pads.

### BACKGROUND

As of 2026, it is estimated that there are 36 million people in the US who are fully edentulous. Globally, about 19% of the population wears some form of denture. In the US, as of 2026, approximately 42 million people wear dentures. The total number of people with edentulism is increasing worldwide, with approximately 25% of adults over the age of 65 being edentulous.

Many dentures are fabricated with substandard results that can be due to poor techniques, poor lab results, poor patient compliance, poor case selection, lack of saliva, etc. resulting in poor denture fit. While it is recommended by the American Dental Association that dentures should be replaced every 5 years due to changes in the bone and tissue as well as wear and tear, most denture wearers are not seen by a dentist after they receive their dentures unless they are having a problem. Most people wear the same set of dentures for 5, 10, 15 years or more.

Dentures may not stay in place and/or may move around due to poor fit, forces from the tongue, and lack of saliva. Solutions include dental implants which are expensive and only a small percentage of patients can afford the treatment, new dentures, in-office or lab relines of the dentures, and use of over the counter dental adhesives. Current dental adhesives consist of pastes, creams, powders, and pre-fabricated generically sized dental adhesive pads. Current dental adhesives may work to a certain extent, but with messy, sticky materials that do not always hold and/or fill the voids between the denture and the tissue.

In order to obtain treatment, new dentures, denture repairs, or denture related products, denture wearers may periodically need to have impressions made of their gums and/or dentures. Often these impressions need to be made in a dentist office. Going to a dentist office may be inconvenient for some patients.

Accordingly, and despite the various advances already made in this field, there is a need for further improvements related to devices, systems, and methods related to adhesive pads for dental appliances and making impressions of dental appliances.

### SUMMARY

Generally, a method of making and shipping or delivering an impression of a gum facing portion of a dental appliance is provided. The method includes pressing the gum facing portion of the dental appliance against a putty in an impression container to make the impression. The method includes allowing the putty to harden and removing the dental appliance from the impression after the putty has hardened. After making the impression, the impression container with the impression is shipped or delivered. The impression in the impression container can be delivered or shipped, for example, to a manufacturing facility, dental office, dental lab, hospital, drugstore, or kiosk.

In some embodiments, the method may include procuring a kit for making the impression of the gum facing portion of the dental appliance. The kit may include the putty for making the impression of the dental appliance and the impression container for holding the putty while making the impression. The putty may include at least two parts and the method may include combining the two parts of the putty. The method may include placing the putty in the impression container. The method may also include placing the impression container with the impression in a shipping container.

Generally, an impression of a gum facing portion of a dental appliance is formed by the process of pressing the gum facing portion of the dental appliance against a putty in an impression container to make the impression. The process includes allowing the putty to harden and removing the dental appliance from the impression after the putty has hardened.

In alternative embodiments, the putty may include at least two parts and the process may include combining the two parts of the putty. The process may include placing the putty in the impression container.

In some aspects, a kit for making an impression of a gum facing portion of a dental appliance includes a putty for making the impression of the gum facing portion of the dental appliance and an impression container for holding the putty while making the impression. The gum facing portion of the dental appliance can be pressed against the putty in the impression container to make the impression. The putty can be allowed to harden. The dental appliance can be removed from the impression after the putty has hardened. The impression in the impression container can be delivered or shipped, for example, to a manufacturing facility, dental office, dental lab, hospital, drugstore, or kiosk for purposes of making adhesive pads for securing the dental appliance.

In some embodiments, the putty may include at least two parts, and combining the parts may cause the putty to harden. The putty may pliable for an interval of time after the parts are combined. The kit may include a shipping container for shipping the impression in the impression container.

Generally, a method of manufacturing a pad to secure a dental appliance to a gum of a patient is provided. The method includes receiving an impression container with an impression of a gum facing portion of the dental appliance. A digital model of a gum facing portion of the dental appliance is created from the impression. The digital model is used to manufacture the pad.

In some embodiments, the method may include 3D scanning the impression of the gum facing portion of the dental appliance to create the digital model. Creating the digital model may include securing the impression container and 3D scanning the impression of the gum facing portion of the dental appliance. Creating the digital model may include trimming at least a portion of the impression of the gum facing portion of the dental appliance. Manufacturing the pad may include creating a profile defining a perimeter of the pad from the digital model and cutting the pad from a sheet of material using the profile. A laser may be used to cut the pad from the sheet of material. An adhesive may be applied to the sheet of material before cutting the pad from the sheet of material. An adhesive may be applied to the pad after cutting the pad from the sheet of material. The method may include storing the digital model electronically. Manufacturing the pad may include 3D printing the pad.

A pad shaped to cover at least a portion of a gum facing portion of the dental appliance and configured to secure a dental appliance to a gum of a patient may be produced using the method described herein. In some embodiments, the pad may include an adhesive coupled to the pad and configured to secure the pad to the dental appliance. The adhesive may be configured to secure the dental appliance to the gum of the patient. The adhesive may cover at least a portion of the pad. The adhesive may be embedded in at least a portion of the pad. The pad may be configured to fill voids at least partially between the gum facing portion of the dental appliance and the gum of the patient.

### BRIEF DESCRIPTION OF THE DRAWINGS

FIG. 1 is a perspective view of an illustrative denture pad and denture.

FIG. 2 is a perspective view of the illustrative denture pad and denture of FIG. 1 showing the denture pad installed on the denture.

FIG. 3 is a perspective view of an illustrative package of a two-part putty.

FIG. 4 is a perspective view of the putty package of FIG. 2 being opened.

FIG. 5 is a perspective view of the two part putty being combined and prepared for use.

FIG. 6 is a perspective view of an illustrative impression container.

FIG. 7 is a perspective view of the impression container of FIG. 5 with putty in a compartment of the impression container.

FIG. 8 is a perspective view of an illustrative impression being made of a gum facing portion of a denture.

FIG. 9 is a perspective view of the impression and denture of FIG. 7.

FIG. 10 is a perspective view of illustrative impressions of an upper denture and a lower denture.

FIG. 11 is a perspective view of an illustrative impression of the gum facing portion of an upper denture in an impression container and an impression trimming tool.

FIG. 12 is a perspective view of a user beginning to trim the impression of FIG. 11.

FIG. 13 is a perspective view of a portion of the impression of FIG. 11 being removed by trimming.

FIG. 14 is a perspective view of the impression of FIG. 11 and showing a trimmed portion.

FIG. 15 is a perspective view of denture pads being cut from a sheet of material.

### DETAILED DESCRIPTION OF THE ILLUSTRATIVE EMBODIMENTS

Impressions of dental appliances, such as dentures for example, are made in dentist offices. Generally, an improved method of making impressions of dental appliances is provided herein. The disclosed method of making impressions of dental appliances may allow the impressions to be made outside of a dentist office. For illustrative purposes and as used herein, the term patient refers to a person who wears dentures and the term caregiver refers to a person who provides care and/or assistance to a person who wears dentures. While the present detailed description is directed at making an impression of a denture for the purposes of making adhesive pads, the invention in its broader aspects may be implemented for making impressions of dental appliances for other purposes.

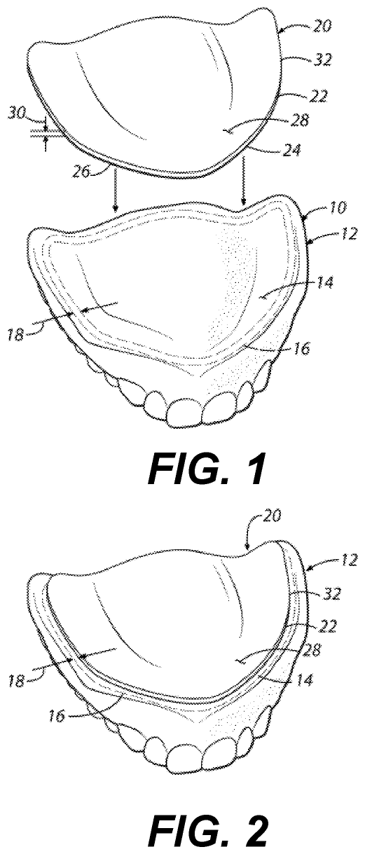

FIG. 1 is a perspective view of an illustrative dental appliance and denture pad and FIG. 2 is a perspective view showing the denture pad installed on the dental appliance. In this illustrative embodiment, the dental appliance 10 is a denture 12. The denture 12 includes a gum facing portion 14 and an edge 16 defining an outline and/or perimeter of the gum facing portion 14. The term “gum facing portion” does not mean to imply that the dental appliance 10 must contact or engage with the gums of a patient but instead is a term that is meant to differentiate the portion of the dental appliance 10 that generally faces the natural gums of a patient from one or more other portions of the dental appliance 10 that do not face the natural gums of the patient. While the denture 12 is illustrated as an upper denture, it will be appreciated that the devices and methods described herein are applicable to both upper and lower dentures, as well as other dental appliances. The term “denture” refers to any denture appliance, such as upper dentures, lower dentures, partial dentures, immediate dentures or any other denture appliance.

The illustrative denture pad 20 includes a pad 22 and an adhesive 24. In this illustrative embodiment, the adhesive 24 covers at least a portion of a denture facing surface 26 of the pad 22. In some embodiments, the adhesive 24 covers or is applied to at least a portion of a gum facing surface 28 of the pad 22. In alternate embodiments, the adhesive 24 may be embedded within the pad 22.

Referring to FIGS. 1 and 2, the pad 22 is shaped to cover a portion of the gum facing portion 14 of the denture 12 to secure the denture 12 against the gums of a patient while the denture 12 is being worn by the patient. The pad 22 is flexible, allowing the pad 22 to conform to the gum facing portion 14 of the denture 12. The pad 22 is sized to be a distance 18 inside of the edge 16 that allows for the fit of the denture pad 20 to the denture 12 and/or to the patient's gums to be tailored to the patient's needs. The distance 18 may be within a range of 0 mm to 15 mm, for example. In this illustrative example, the pad 22 is sized to be a distance 18 of 5 mm inside of the edge 16. The distance 18 may vary around a perimeter 32 or outer edge of the denture pad 20. In this illustrative example, the denture pad 20 is intended to be replaced daily. A patient or caregiver installs the denture pad 20 on the denture 12 before placing the denture 12 against the patient's gums. The patient or caregiver removes the denture pad 20 from the denture 12 when the denture 12 is removed from the patient's mouth. In some embodiments, the denture pad 20 may allow the denture 12 to be positioned and repositioned on the patient's gums without the need to replace the denture pad 20.

The pad 22 has a thickness 30, and the thickness 30 of the pad 22 may vary depending on the fit requirements of the patient and/or the denture 12. The pad 22 has a stiffness, and the stiffness of the pad 22 may vary depending on the fit requirements of the patient and/or the denture 12. In some embodiments, the denture pad 20 and/or pad 22 may be constructed of a plurality of layers, the sum of the thicknesses of the layers equaling the thickness 30 of the pad 22. The layers may have varying thicknesses and/or stiffnesses. Some patients may achieve an acceptable denture fit with a stiffer or less pliable pad 22 with a relatively small thickness 30, for example. Other patients may require a softer or more pliable pad 22 with relatively large thickness 30 to compensate for contour differences between the gum facing portion 14 of the denture 12 and the patient's gums to achieve an acceptable fit of the denture 12, for example. In some embodiments, the thickness 30 is not uniform throughout the pad 22. The plurality of combinations of stiffness and/or thickness 30 of the pad 22 allow for the fit of the denture pad 20 to the denture 12 and/or to the patient's gums to be tailored to the patient's needs. The denture pad 20 is custom fit to the denture 12 as described herein. A patient who wears both upper and lower dentures would use a unique denture pad 20 for each of the upper and lower dentures.

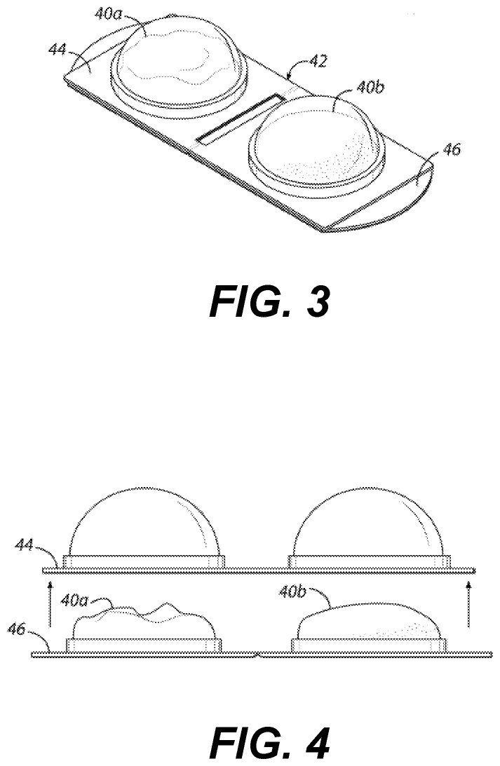

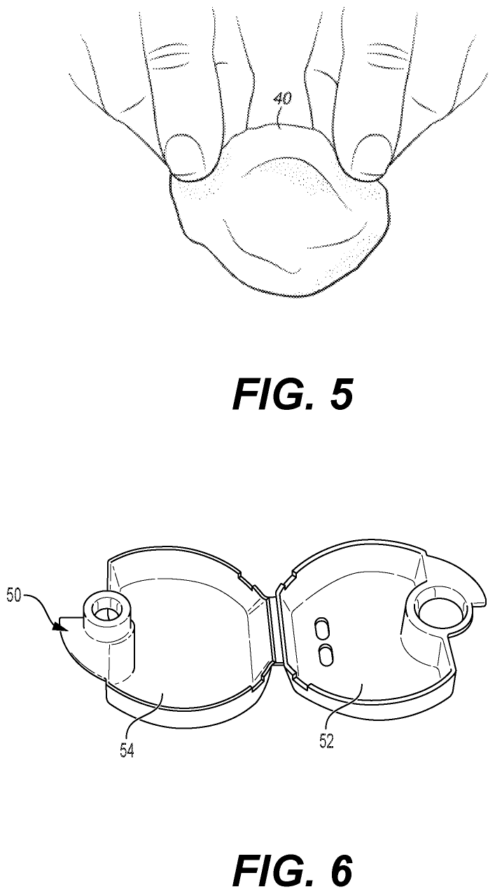

FIG. 3 is a perspective view of an illustrative two-part putty 40 in an illustrative package 42, FIG. 4 is a perspective view showing the package 42 being opened, and FIG. 5 is a perspective view of the two parts 40a, 40b of the putty 40 being combined for use. In some embodiments, the method of creating an impression includes combining at least two parts 40a, 40b of the putty 40. In this illustrative example, the two parts 40a, 40b of the putty 40 are provided in a package or container 42 with a base 46 and a lid 44. In some embodiments, combining the two parts 40a, 40b of the putty 40 includes removing the lid 44 from the base 46 of the container 42, as shown if FIG. 3, removing the two parts 40a, 40b from the container 42, and mixing the two parts 40a, 40b to make the putty 40. Mixing the two parts 40a, 40b may include kneading the two parts 40a, 40b, as shown in FIG. 5, until the putty 40 is a uniform consistency. In some embodiments, the two parts 40a, 40b may be different colors and mixing the two parts 40a, 40b may include mixing and/or kneading until the putty 40 is a uniform color. In other embodiments, the putty may any material suitable for making an impression of a dental appliance.

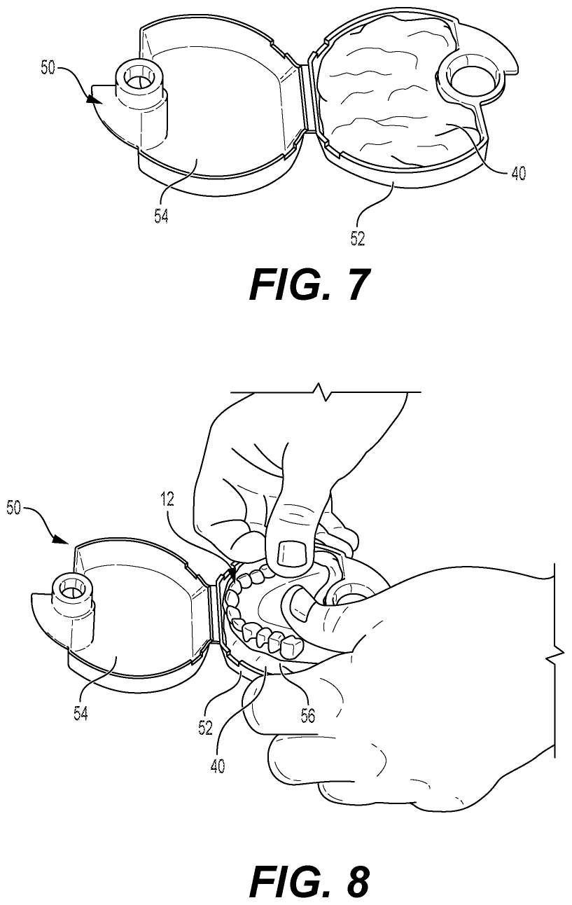

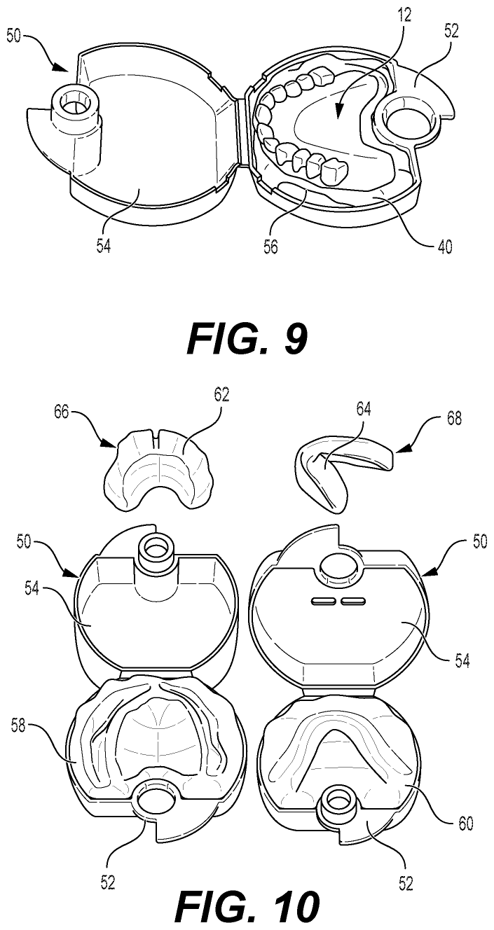

FIGS. 6-10 progressively illustrate a method or process of creating an impression of the gum facing portion of a dental appliance. FIG. 6 is a perspective view of an illustrative impression container 50. The impression container 50 includes a compartment 52 and a lid 54. As described above, the two parts 40a, 40b of the putty 40 are combined. As shown in FIG. 7, the putty 40 is pressed into the compartment 52 of the impression container 50. FIG. 8 illustrates an impression 56 being made of a gum facing portion of a denture 12 by pressing the denture 12 into the putty 40. The impression container 50 holds the putty 40 while the impression 56 is being made. FIG. 9 is a perspective view of the impression 56 and denture 12 in the impression container while the putty 40 hardens or cures. After the putty 40 has hardened or cured, the denture 12 is removed from the impression 56. The lid 54 of the impression container 50 is then closed thereby protecting the impression 56 inside the impression container 50.

In some cases, a patient, caregiver, nurse, pharmacist, or pharmacy tech, for example, may make the impression 56. In other cases, a dental technician or dentist, for example, may make the impression 56. A patient, for example, would only need to wait a short period of time for the putty 40 to harden and/or cure before removing the impression 56 from the denture 12, thereby minimizing the time a patient would not have the use of the denture 12. It should be appreciated by one of ordinary skill in the art that the cure time of the putty 40 may vary and may be tailored to allow for longer or shorter cure times to aid in the creation of the impression 56. In some embodiments, the putty 40 may be polyvinyl siloxane, silicone, or similar material that is suitable to obtain an accurate and stable impression 56. The impression 56 needs to remain accurate and dimensionally stable over an extended period of time which could include incidental events such as delays in shipping, temperature changes, etc. Shipping the impression 56 may include placing the impression container 50 with the impression 56 inside in a shipping container such as a mailing pouch or box and sending the impression container 50 with the impression 56 through the US mail, for example. FIG. 10 is a perspective view of illustrative impressions 58, 60 of the gum facing portions 62, 64 of an upper denture 66 and a lower denture 68 respectively. The lids 54 of the impression containers 50 may be closed and the protected impressions 58, 60 may be shipped or delivered within the impression containers 50. The impression containers 50 may be used to protect and store the impressions 58, 60.

An illustrative method of manufacturing a denture pad 20 includes creating an impression 58, 60 of the gum facing portion 62, 64 of a denture 66, 68, see FIG. 10, and scanning at least a portion of the impression 58, 60 to create a digital model of the gum facing portion of the denture 66, 68 to produce the denture pad 20. The impression 58, 60 in an impression container 50 is delivered to a 3D scanner location for 3D scanning of the impression 58, 60. 3D scanners may be in manufacturing facilities, dental offices, dental labs, hospitals, drugstores, and/or kiosks, for example. Delivery of the impression 58, 60 to a 3D scanner location may include placing the impression container 50 with the impression 58, 60 in a mailing pouch or box and sending the impression 58, 60 through the US mail, for example. In some cases, a patient or caregiver, for example, would take the impression container 50 with the impression 58, 60 to a dental office, dental lab, hospital, drugstore, or kiosk to have the impression 58, 60 3D scanned. In some cases, a dental technician, dentist, nurse, pharmacist, or pharmacy tech, for example, would 3D scan the impression 58, 60.

3D scanning includes using a 3D scanner, or similar device, to 3D scan and/or measure the impression 58, 60. In some instances, the impression container 50 may be secured in the 3D scanner and the impression 58, 60 may be scanned while remaining in the impression container 50. The 3D scan of the impression 58, 60 is used to create a digital model of the gum facing portion 62, 64. In some methods, the digital model may be a 3D model. In some methods, the digital model may be a 2D model. The digital model is stored electronically for later use, along with an identification number and information associated with the patient, for example.

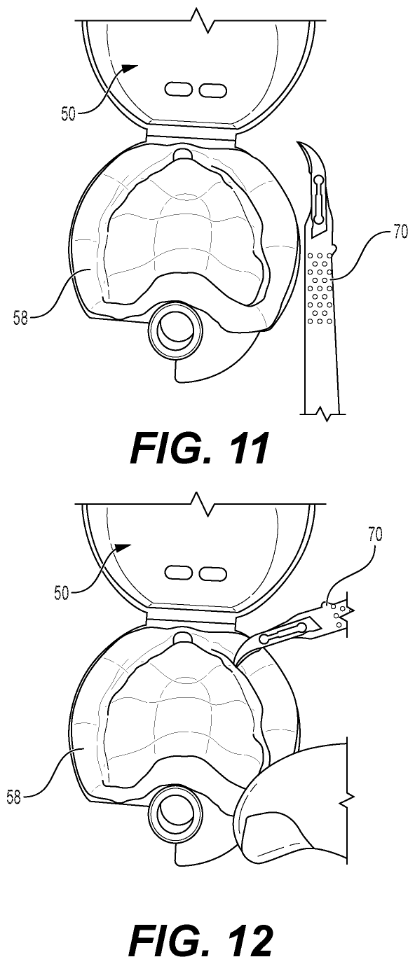

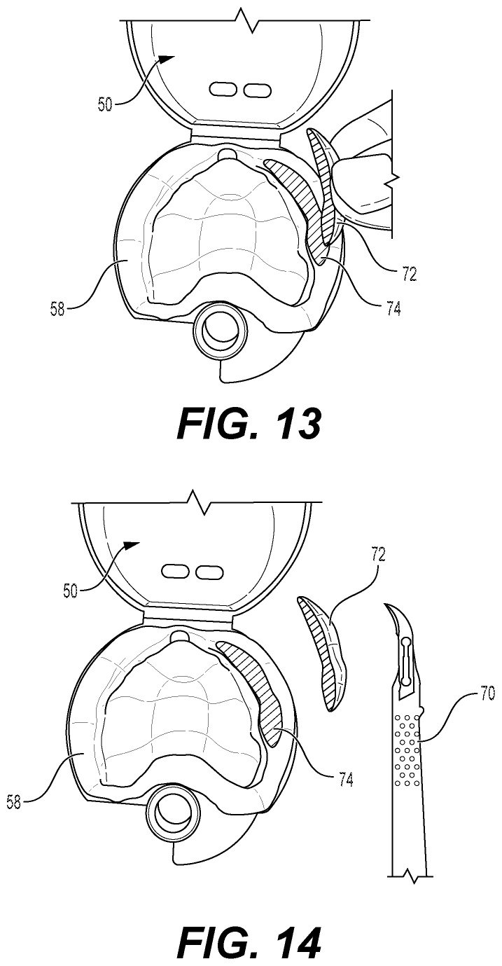

FIGS. 11-14 progressively illustrate a method or process of trimming an impression. In some cases, an impression may need to be trimmed, such as prior to 3D scanning to capture a complete and accurate 3D scan of the impression of the gum facing portion of a denture, for example. FIG. 11 shows an illustrative impression 58 of the gum facing portion of an upper denture in an impression container 50 and a trimming tool 70. The trimming tool 70 is illustrated as a utility knife, but may be any tool suitable for trimming impression material. FIG. 12 shows a user, such as a lab technician for example, beginning to trim the impression 58 with the trimming tool 70. A user may trim a portion of the impression 58 to allow an unobstructed view of the impression for a 3D scanner, for example. A user may trim off one or more portions 72 of the impression 58 creating one or more trimmed portions 74 allowing for an unobstructed view of the impression 58 for a 3D scanner, for example, see FIG. 13. FIG. 14 is a perspective view of a portion 72 of the impression 58 removed creating a trimmed portion 74.

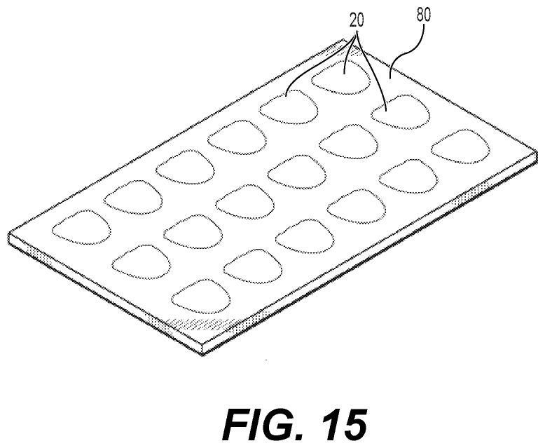

Referring to FIGS. 1 and 15, in this illustrative embodiment, the denture pad 20 or pad 22 is cut from a sheet 80. In this illustrative embodiment, the sheet 80 includes the material to make the pad 22 and the adhesive 24. Cutting the denture pad 20 and/or pad 22 from the sheet 80 may involve die cutting, laser cutting, and/or other methods for cutting a shape from the sheet 80. In some embodiments, the digital model is used to create a profile defining the perimeter 32 or outer edge of the denture pad 20 and/or pad 22. In some embodiments, the profile is used to program a cutting machine, such as a laser, for example, to cut the denture pad 20 and/or pad 22 from the sheet 80. In some embodiments, the profile is used to make tooling, such as a die for use in a cutting machine, for example, to cut the denture pad 20 and/or pad 22 from the sheet 80.

In some embodiments, the sheet 80 includes the adhesive 24 and cutting the denture pad 20 from the sheet 80 produces the denture pad 20. In some embodiments, the adhesive 24 is applied to the sheet 80 before the denture pad 20 is cut from the sheet 80. In some embodiments, the adhesive 24 is applied to the pad 22 after the pad 22 is cut from the sheet 80 to produce the denture pad 20. In some embodiments, the sheet 80 includes a plurality of layers. In some embodiments, the denture pad 20 and/or pad 22 is cut from a plurality of sheets 60 and the plurality of cut layers are combined to produce the denture pad 20.

In alternate embodiments, the denture pad 20 and/or pad 22 may be constructed using 3D printing or similar additive manufacturing process, for example. The digital model is used to program the 3D printer and/or additive manufacturing machine or machines. In some embodiments, the denture pad 20 and/or pad 22 may be constructed of multiple layers of material of varying stiffness and/or thickness, for example. In some embodiments, the adhesive 24 is applied to the denture pad 20 and/or pad 22 as part of the 3D printing process. In some embodiments, the adhesive 24 is applied to the pad 22 after the pad 22 is 3D printed to produce the denture pad 20. In some embodiments, the adhesive 24 is a component of the materials used to 3D print the denture pad 20 and/or pad 22. In some embodiments, the denture pad 20 and/or pad 22 is 3D printed as a flat component. In alternate embodiments, the denture pad 20 and/or pad 22 is 3D printed with a contour matching the gum facing portion 14 of the denture 12.

The digital model is stored electronically, and additional adhesive denture pads 20 can be manufactured using the stored digital model. A patient, caregiver, dentist, lab, or technician can order adhesive denture pads 20 as needed and the adhesive pads 20 can be delivered to the patient or caregiver, for example. Adhesive pads 20 can easily be ordered through a website, an app on a mobile device, and/or by making a phone call, for example. Alternatively, a patient or caregiver can receive adhesive denture pads 20 as part of a subscription service, receiving a periodic 30-, 60-, or 90-day supply, for example. Some methods of providing the denture pad 20 to a patient or caregiver include providing an impression kit including the putty 40, the impression container 50, and a shipping container such as a mailing pouch or a box to a patient or caregiver, for example. Impression kits and/or adhesive denture pads 20 may be sold directly to dental offices, for example. Dental offices may provide impression kits and/or adhesive denture pads 20 directly to patients or caregivers, for example. Dental offices with the appropriate equipment may produce impression kits and/or adhesive denture pads 20, for example. The impression kit can be sold to patients, caregivers, and other consumers through retailers such as pharmacies, department stores, and on-line retailers, for example. The impression kit could also be sold or provided directly to patients, caregivers, and other consumers by the manufacturer of the denture pad 20.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A method of making and shipping or delivering an impression of a gum facing portion of a dental appliance, the method comprising:
pressing the gum facing portion of the dental appliance against a putty in an impression container;
allowing the putty to harden to make the impression;
removing the dental appliance from the impression after the putty has hardened; and
at least one of shipping or delivering the impression container with the impression.

2. The method of claim 1, further comprising procuring a kit for making the impression of the gum facing portion of the dental appliance, the kit including:
the putty for making the impression of the dental appliance, and
the impression container for holding the putty while making the impression.

3. The method of claim 1, wherein the putty includes at least two parts, and
the method further comprises combining the at least two parts of the putty.

4. The method of claim 1, further comprising placing the putty in the impression container.

5. The method of claim 1, further comprising placing the impression container with the impression in a shipping container.

6. A kit for making an impression of a gum facing portion of a dental appliance, the kit comprising:
a putty for making the impression of the gum facing portion of the dental appliance; and
an impression container for holding the putty while making the impression;
wherein the gum facing portion of the dental appliance can be pressed against the putty in the impression container to make the impression, the putty can be allowed to harden, the dental appliance can be removed from the impression after the putty has hardened, and the impression in the impression container can be at least one of shipped or delivered.

7. The kit of claim 6, wherein the putty comprises at least two parts, combining the at least two parts causes the putty to harden, and the putty is pliable for an interval of time after the at least two parts are combined.

8. The kit of claim 6, further comprising a shipping container for shipping the impression in the impression container.

9. A method of manufacturing a pad to secure a dental appliance to a gum of a patient, the method comprising:
receiving an impression container with an impression of a gum facing portion of the dental appliance;
creating a digital model of a gum facing portion of the dental appliance from the impression; and
using the digital model to manufacture the pad.

10. The method of claim 9, wherein creating the digital model comprises 3D scanning the impression of the gum facing portion of the dental appliance.

11. The method of claim 9, wherein creating the digital model comprises:
securing the impression container; and
3D scanning the impression of the gum facing portion of the dental appliance.

12. The method of claim 9, wherein creating the digital model comprises trimming at least a portion of the impression of the gum facing portion of the dental appliance.

13. The method of claim 9, wherein manufacturing the pad comprises:
creating a profile defining a perimeter of the pad from the digital model; and
cutting the pad from a sheet of material using the profile.

14. The method of claim 13, comprising using a laser to cut the pad from the sheet of material.

15. The method of claim 13, further comprising applying an adhesive to the sheet of material before cutting the pad from the sheet of material.

16. The method of claim 13, further comprising applying an adhesive to the pad after cutting the pad from the sheet of material.

17. The method of claim 9, further comprising storing the digital model electronically.

18. The method of claim 9, wherein manufacturing the pad comprises 3D printing the pad.
